(19) United States
(12) Patent Application Publication
(10) Pub. No.: US 2012/0158582 A1
(43) Pub. Date: Jun. 21, 2012

(54) PAYMENT SYSTEM USING IMAGES

(75) Inventor: Frank Anthony Nuzzi, Pflugerville, TX (US)

(73) Assignee: EBAY INC., San Jose, CA (US)

(21) Appl. No.: 12/973,143

(22) Filed: Dec. 20, 2010

(51) Int. Cl. G06Q 40/00

(52) U.S. Cl. 705/40

(57) ABSTRACT

A method for making a payment using an image includes receiving an image from a camera. The image is analyzed using a processor. A payee indicator that is included in the image is determined. Payee information from a database is retrieved using the payee indicator. A request to make a payment to a payee is sent over a network using the payee information. Thus, a payer may take an image that includes a payee indicator and the method will use that payee indicator to retrieve payee information that may include a current payment due to the payee and a due date for that payment, and the payer may quickly and easily send a request to make that payment to a payment service provider to ensure that the payment is made to the payee.

### BACKGROUND

1. Field of the Invention

The present invention generally relates to online and/or mobile payments and more particularly to a payment system using images.

2. Related Art

More and more consumers are purchasing items and services over electronic networks such as, for example, the Internet. Consumers routinely purchase products and services from merchants and individuals alike. The transactions may take place directly between an on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line purchases are growing very quickly.

Typically, on-line or mobile payments are conducted by a payer using a payer device to access a payer account with the payment service provider, logging into the payer account, and then instructing the payment service provider to make a payment to a payee by designating the payee, designating a payment amount, and designating a date to send the payment. As can be seen, such conventional systems require several steps to be conducted by the payee in order to instruct the payment service provider to make the payment. The time and effort necessary to conduct these steps may cause the payer to put off instructing the payment service provider to make the payment. For example, the payer may see an advertisement from a payee to which the payer would like to make a payment, and because of the time and effort needed to instruct the payment service provider to do so, the payer may put off making the instruction and, in some cases, miss making the payment.

Thus, there is a need for an improved payment system.

### SUMMARY

According to one embodiment, a method for making a payment using an image includes receiving an image from a camera, analyzing the image using a processor and determining that a payee indicator is included in the image, retrieving payee information from a database using the payee indicator, and sending a request to make a payment to a payee over a network using the payee information.

In an embodiment, the method retrieves and displays a current amount due to the payee, and may receive a confirmation from a payer to send the request to make the payment to the payee. In another embodiment, the sending of the request to make the payment to the payee may occur automatically in response to receiving the image including the payee indicator.

As a result, a payer may simply take an image that includes a payee indicator in order to quickly and easily send a request to a payment service provider to make that payment to ensure that the payment is made to the payee.

These and other features and advantages of the present disclosure will be more readily apparent from the detailed description of the embodiments set forth below taken in conjunction with the accompanying figures.

### BRIEF DESCRIPTION OF THE FIGURES

FIG. 1a is a flow chart illustrating an embodiment of a method for making a payment using images;

FIG. 1b is a perspective view illustrating an embodiment of a payer taking an image;

FIG. 1c is a front view illustrating an embodiment of an image displayed on a payer device;

FIG. 1d; is a screenshot view illustrating an embodiment of a screen for making a payment using the payer device of FIG. 1c;

FIG. 2a is a perspective view illustrating an embodiment of a payer taking an image;

FIG. 2b is a front view illustrating an embodiment of an image displayed on a payer device;

FIG. 2c is a screenshot view illustrating an embodiment of a screen for making a payment using the payer device of FIG. 2b;

FIG. 3a is a perspective view illustrating an embodiment of a payer taking an image;

FIG. 3b is a front view illustrating an embodiment of an image displayed on a payer device;

FIG. 3c is a screenshot view illustrating an embodiment of a screen for making a payment using the payer device of FIG. 2b;

FIG. 4 is a schematic view illustrating an embodiment of a networked system;

FIG. 5 is a perspective view illustrating an embodiment of a payer device;

FIG. 6 is a schematic view illustrating an embodiment of a computer system; and

FIG. 7 is a schematic view illustrating an embodiment of a payer device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for making a payment using an image with the assistance of a payment service provider. A payer may take an image using a camera on a mobile device, and that image may be analyzed to determine that a payee indicator (e.g., a company logo or brand, a company name, a company trademark, a product image, etc.) is included in the image. The payee indicator may then be used to retrieve payee information that may include a payment due to the payee, and that payment may then be paid by the payment service provider. In one embodiment, the payer may provide payment variables that modify the amount of the payment due to the payee and/or provide a confirmation of the payment. In another embodiment, the payment may be automatically paid in response to determining the payee indicator is included in the image. The system and method allow a payer to easily and quickly make a payment to a payee by simply taking an image that includes a payee indicator.

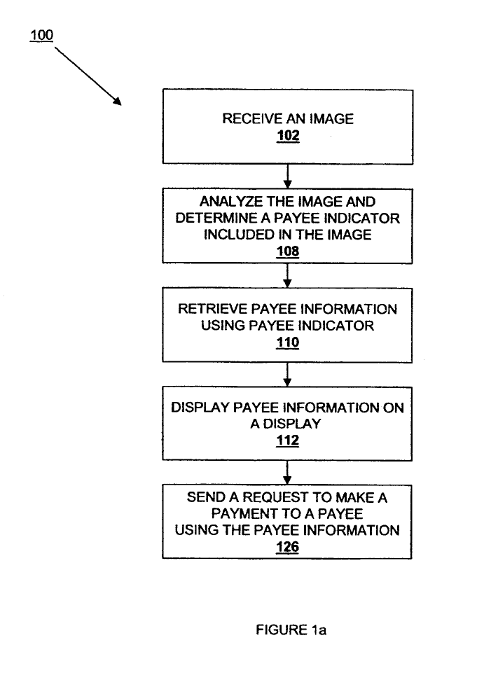

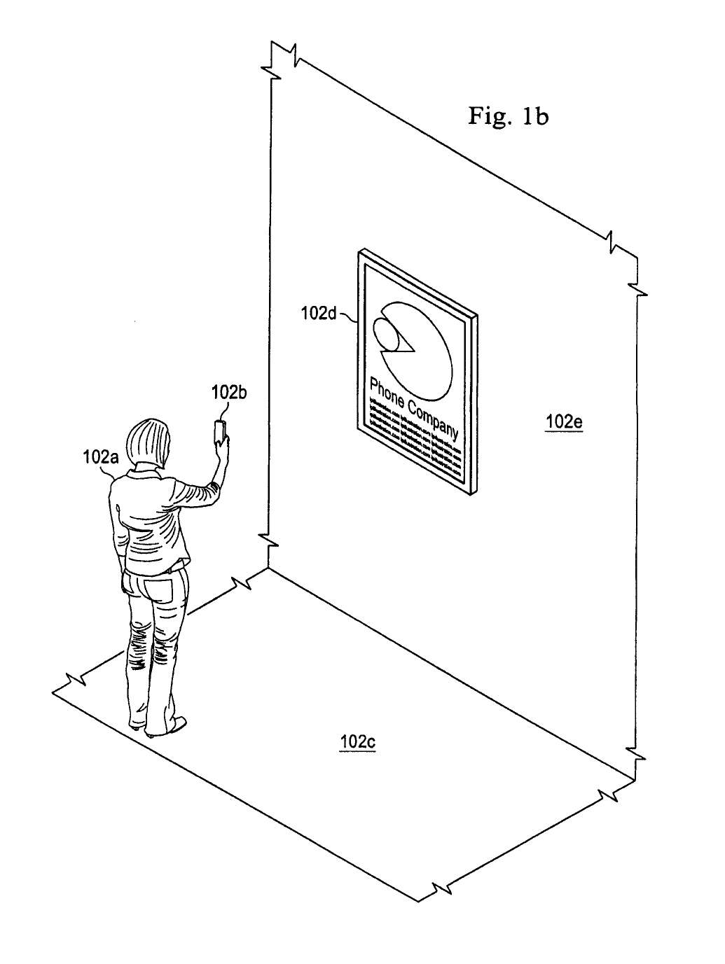

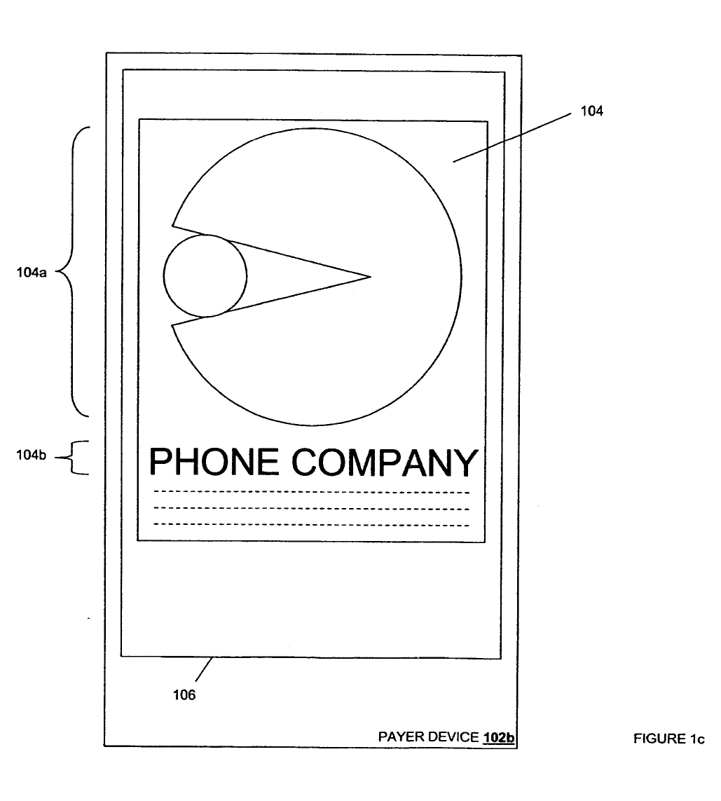

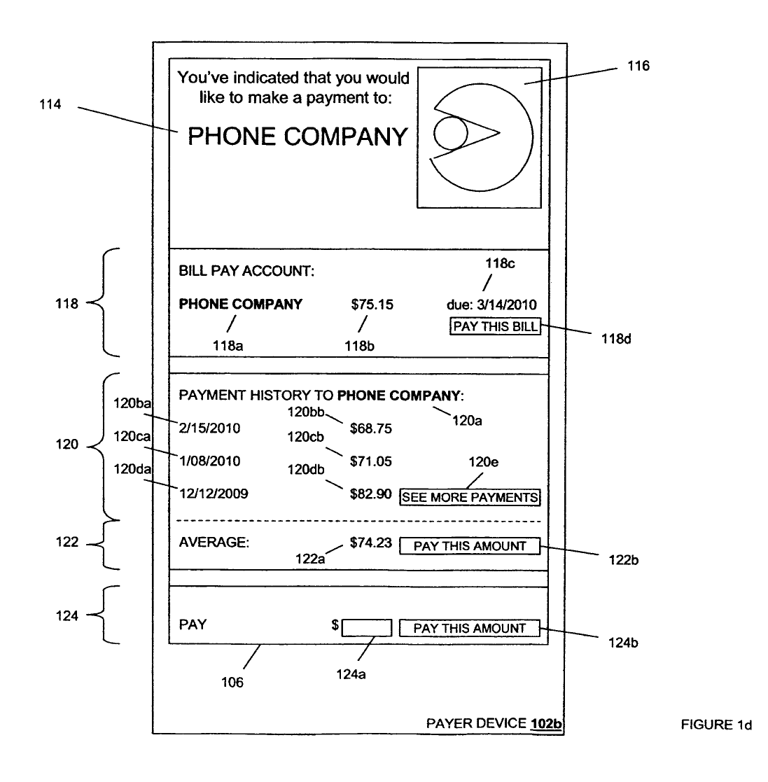

Referring now to FIGS. 1a, 1b, and 1c, a method 100 for making a payment using an image is illustrated. The method 100 begins at block 102 where an image is received. A payer 102a having a payer device 102b may take an image using a camera in the payer device 102b. In the illustrated embodiment, the payer device 102b is a mobile device known in the art that may run one or more software applications that allow the method 100 to be performed, as described in further detail below, and the payer 102a is located on a sidewalk 102c next to an advertisement 102d positioned on a wall 102e. The payer 102a may be traveling along the sidewalk 102c when the payer 102a notices the advertisement 102d and recognizes that the advertisement 102d is for a company or other entity to which the payer 102a may owe or wish to make a payment. The payer 102a may then use the payer device 102b to take an image of the advertisement 102d using a camera that is included in the payer device 102a, as illustrated in FIG. 1b. For example, an image 104 that is taken of the advertisement 102d by the payer 102a may be displayed on a display 106 of the payer device 102b, as illustrated in FIG. 1c. The image 104 may include one or more payee indicators 104a and 104b. In the illustrated embodiment, the payee indicator 104a is a company logo, brand, trademark, product, service, and/or other symbol or insignia that may be associated with a payee, as described in further detail below, and the payee indicator 104b is a company name, trademark, slogan, and/or other phrase or character string that may be associated with a payee, as described in further detail below. The image 104 taken by the payer device 102b may be received by the one or more software applications that are performing the method 100. While the image 104 has been described above as being taken from an advertisement on a wall from a sidewalk, one of skill in the art will recognize that the image including the payee indicators 104a and/or 104b may be taken from a variety of different display mediums with the payer device 102b in a variety of different locations such as, for example, from a display screen, a piece of clothing, etc., with the payer device in a home, a movie theater, stores, etc., without departing from the scope of the present disclosure.

Referring now to FIGS. 1a and 1c, the method 100 then proceeds to block 108 where the image is analyzed and it is determined that a payee indicator is included in the image. The image 104 received in block 102 of the method 100 may be analyzed using image and/or character recognition technology and techniques to determine if the image includes a payee indicator. The analyzing may be performed within the payer device 102b or by a payment/service provider after the image has been sent from the payer device 102b to the payment/service provider. In the embodiment illustrated in FIG. 1c, the image 104 may be analyzed and it may be determined that the payee indicator 104a and/or the payee indicator 104b are possible payee indicators, and then a database may be accessed (e.g., on the payer device 102b or over a network) to determine if the possible payee indicators from the analyzed image 104 correspond to confirmed payee indicators that are stored in the database. Confirmed payee indicators may be stored in the database by payees (e.g., company's may provide payee indicator(s) that they are associated with), payers (e.g., a payer may provide payee indicator(s) and indicate which payee(s) they should be associated with), and/or other entities that may wish to enable the method of the present disclosure. In one example, a payer may provide a “custom” payee indicator that is not normally associated with a payee and indicate that that payee indicator should be associated with the payee (e.g., the payer may indicate that an image including an orange should be associated with a utility company to which the payer makes payments.) In the illustrated embodiment, the image 104 is analyzed to determine that the payee indicator 104a (e.g., a company logo, brand, trademark, and/or other symbol or insignia associated with a company) is a possible payee indicator, and then a database is accessed and it is determined that the payee indicator 104a corresponds to a confirmed payee indicator in the database, and/or determine that the payee indicator 104b (e.g., a company name, trademark, slogan, and/or other phrase or character string) is a possible payee indicator, and then a database is accessed and it is determined that the payee indicator 104b corresponds to a confirmed payee indicator in the database. In an embodiment, a confirmed payee indicator includes information for a payee that the confirmed payee indicator is associated with such as, for example, a payee name, payee contact information, and/or a variety of other payee information known in the art.

Referring now to FIGS. 1a and 1c, the method 100 then proceeds to block 110 where payee information is retrieved using a payee indicator. As discussed above, the payee indicators 104a and/or 104b, which are now confirmed payee indicators, include information for the payee with which they are associated. Using information from the payer (e.g., retrieved from the payer device 102b) and information associated with the payee indicators 104a and/or 104b, a database is accessed to retrieve payee information that is related to payments made and/or owed to the payee by the payer. For example, a database may be accessed using the information from the payer that includes an account of the payer, and using the information associated with the payee indicators 104a and/or 104b, a payment due from the payer to the payee may be retrieved, a due date for that payment may be retrieved, a plurality of payments previously made by the payer to the payee may be retrieved, and/or a variety of other payee information known in the art may be retrieved.

Referring now to FIGS. 1a and 1d, the method 100 then proceeds to block 112 where the payee information is displayed. Information determined in blocks 108 and 110 of the method 100 may be displayed on the display 106 of the payer device 102b. For example, in the illustrated embodiment in FIG. 1d, a payee name 114 and a payee image 116 associated with a payee (which is associated with the payee information retrieved in block 110 of the method 100) are displayed adjacent a statement that informs the payer that they have indicated they would like a payment to the payee. In an embodiment, the payee name 114 may be the payee indicator 104b described above (e.g., when the payee indicator 104b is a company name), and the payee image 116 may be retrieved from a database due to its association with the payee indicator 104b. In an embodiment, the payee image 116 may be the payee indicator 104a described above (e.g., when the payee indicator 104a is a company logo), and the payee name 114 may be retrieved from a database due to its association with the payee indicator 104a. In an embodiment, the payee name 114 and payee image 116 may be the payee indicator 104b and payee indicator 104a, respectively (e.g., when the payee indicator 104a is a company logo and the payee indicator 104b is a company name.) In an embodiment, the payee name 114 and payee image 116 may be retrieved from a database due to their association with the payee indicator(s) 104a and/or 104b (e.g., when the payee indicator 104a is a product produced by a company and/or when the payee indicator 104b is a company slogan.)

In the illustrated embodiment, a Bill Pay Account section 118 is displayed. For example, in block 110 of the method 100, a payment due from the payer to the payee and a due date for that payment has been retrieved, and a payee name 118a, a current amount due 118b, a date due 118c, and a Pay This Bill button 118d are displayed in the Bill Pay Account section 118.

In the illustrated embodiment, a Payment History section 120 is also displayed. For example, in block 110 of the method 100, a plurality of payments previously made by the payer to the payee has been retrieved, and a payee name 120a, a first payment date 120ba and associated first payment 120bb, a second payment date 120ca and associated second payment 120cb, a third payment date 120da and associated third payment 120db, and a See More Payments button 120 are displayed in the Payment History section 120.

In the illustrated embodiment, an Average Payment section 122 is also displayed. For example, for the first payment 120bb, the second payment 120cb, and a third payment 120db in the Payment History section 120, and average payment 122a may be determined and displayed along with a Pay This Amount button 122b in the Average Payment section 122.

In the illustrated embodiment, an Editable Payment section 124 is also displayed. For example, a payee option such as a payment input 124a, along with a Pay This Amount button 124b, are displayed in the Editable Payment section 124.

Referring now to FIGS. 1a and 1d, the method 100 then proceeds to block 126 where a request is sent to a payment service provider to make a payment to a payee using the payee information. The payer 102a may use the Bill Pay Account section 118, the Payment History section 120, the Average Payment section 122, and/or the Editable Payment section 124 to send a request (e.g., over a network) to a payment service provider to make a payment to a payee. For example, the payer 102a may use the Bill Pay Amount section 118 to send a request to a payment service provider to pay the current amount due 118b to a payee associated with the payee name 118a by selecting the Pay This Bill button 118d, which will cause the request to be sent over a network to a payment service provider and result in the payment service provider using an account of the payer to make a payment of the current amount due 118b to the payee. In an embodiment, the selection of the Pay This Bill button 118d may be interpreted as a confirmation and/or authorization by the payer to the payment service provider to make the payment.

In another example, the payer 102a may use the Average Payment section 122 to send a request to a payment service provider to pay the average payment 122a to a payee associated with the payee name 120a (located in the Payment History section 120) by selecting the Pay This Amount button 122b, which will cause the request to be sent over a network to a payment service provider and result in the payment service provider using an account of the payer to make a payment of the average payment 122a to the payee. In an embodiment, the selection of the Pay This Amount button 122b may be interpreted as a confirmation and/or authorization by the payer to the payment service provider to make the payment. In an embodiment, the payer 102a may select the See More Payments button 120 in the Payment History section 120 in order to display more payments and associated payment dates (similar to the first, second, and third payments 120ba, 120ca, and 120da and their associated payment dates 120bb, 120cb, and 120db, respectively), and then may, for example, use those payments to recalculate the average payment 122a or select a payment that is associated with a payment date that is similar to the current date and send a request to a payment service provider to pay the payee an amount equal to the payment.

In another example, the payer 102a may use the Editable Payment section 124 to send a request to a payment service provider by inputting a payment variable (e.g., a payment amount) into the payment input 124a and selecting the Pay This Amount button 124b, which will cause the request to be sent over a network to a payment service provider and result in the payment service provider using an account of the payer to make a payment of amount input into the payment input 124a to the payee. In an embodiment, the selection of the Pay This Amount button 124b may be interpreted as a confirmation and/or authorization by the payer to the payment service provider to make the payment.

In one embodiment, the display and confirmation described above with reference to block 112 of the method 100 may be skipped and the taking of the image may be interpreted as a confirmation and/or authorization by the payer to the payment service provider to make the payment. As such, the receiving of the image may, upon the retrieval of the payee information subsequent to the determination of the payee indicator(s), automatically result in the sending of the request to make the payment (e.g., for the amount due 118b retrieved in block 110 of the method 100.) Furthermore, the retrieval and display of payee information in blocks 110 and 112 may include the retrieval and display of advertisements or deals from the payee. For example, at block 112 of the method 100, an advertisement or deal from a payee, retrieved in block 110, may be displayed that offers a discount for a purchase/payment made immediately after that payment is displayed (e.g., “buy this product now and receive a 10% discount.”) Note that the steps described herein are typically performed electronically, such as transmitted, received, processed by one or more devices.

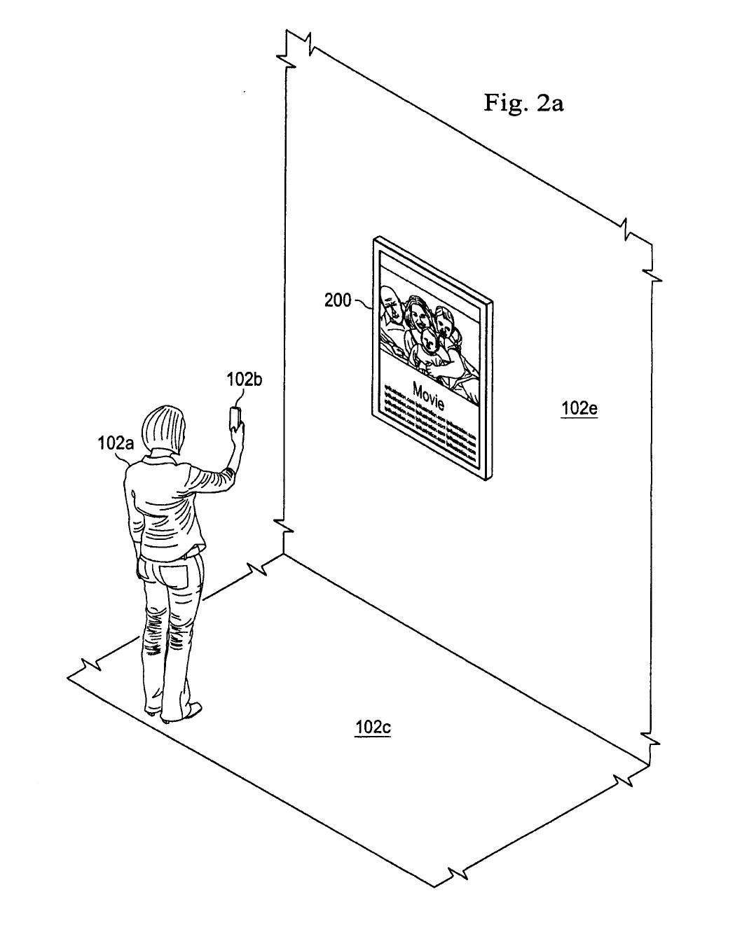

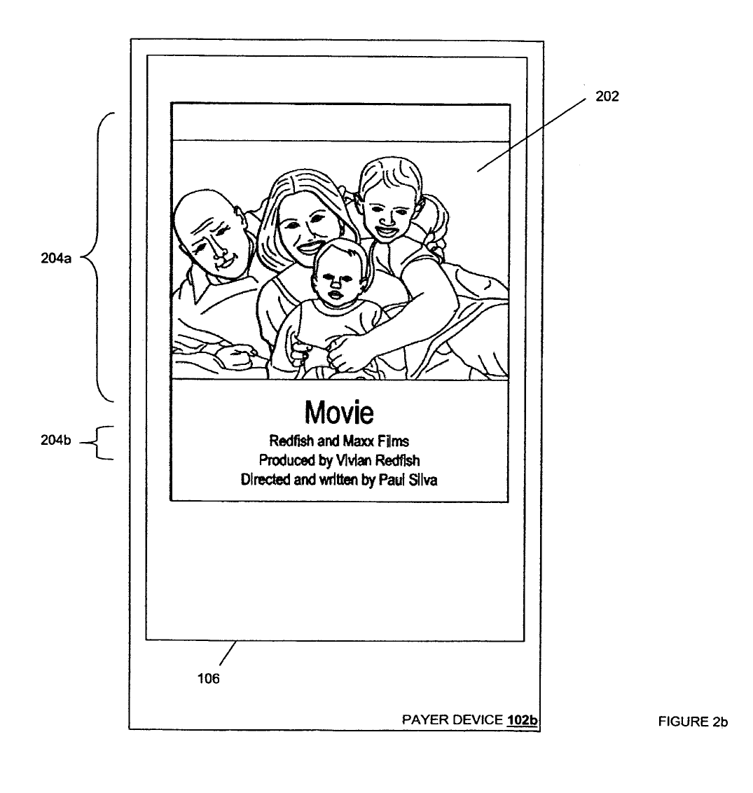

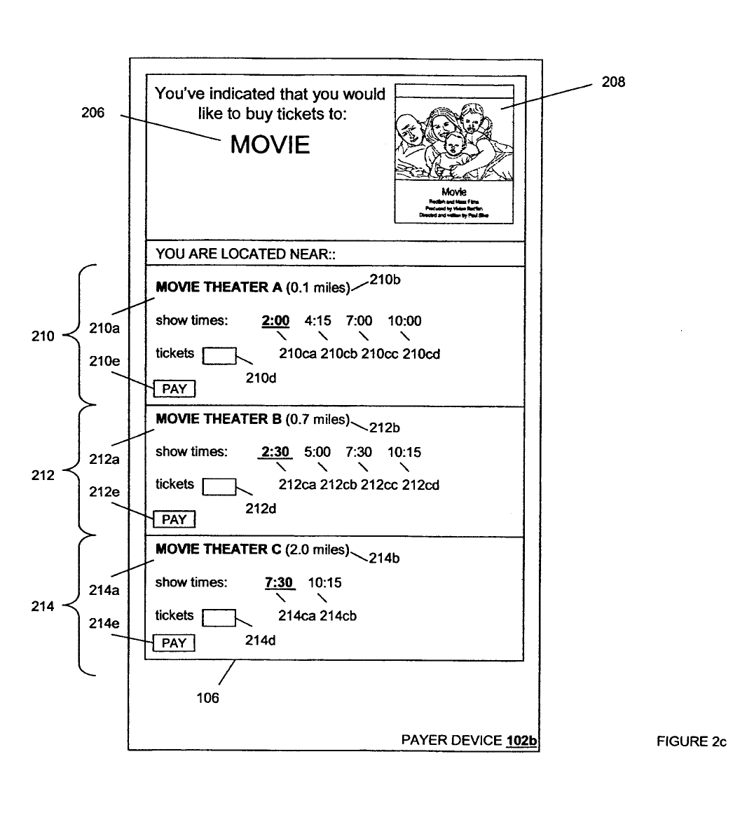

Referring now to FIGS. 1a, 2a, 2b, and 2c, another embodiment of the method 100 is illustrated. The illustrated embodiment has a modified block 102 where an image is received. As discussed above, a payer 102a having a payer device 102b may take an image using a camera in the payer device 102b. In the illustrated embodiment, and the payer 102a is located next to a movie advertisement 200 positioned on a wall 102e. For example, the payer 102a may be at or near a movie theater when the payer 102a notices the movie advertisement 200 (e.g., a movie poster) and decide that the payer 102a would like to go see a movie associated with the move advertisement 200. The payer 102a may then use the payer device 102b to take an image of the movie advertisement 200 using a camera that is included in the payer device 102a, as illustrated in FIG. 2a. For example, an image 202 that is taken of the movie advertisement 200 by the payer 102a may be displayed on a display 106 of the payer device 102b, as illustrated in FIG. 2b. The image 202 may include one or more payee indicators 204a and 204b. In the illustrated embodiment, the payee indicator 204a is an image that may be associated with a movie, as described in further detail below, and the payee indicator 204b is a movie name, movie catch phrase and/or other phrase or character string that may be associated with a movie, as described in further detail below.

Referring now to FIGS. 1a and 2b, the illustrated embodiment of the method 100 has a modified block 108 where the image is analyzed and it is determined that a payee indicator is included in the image. The image 202 received in block 102 of the method 100 may be analyzed using image and/or character recognition technologies and techniques to determine if the image includes a payee indicator. In the embodiment illustrated in FIG. 2b, the image 202 may be analyzed and it may be determined that the payee indicator 204a and/or the payee indicator 204b are possible payee indicators, and then a database may be accessed (e.g., over a network) to determine if the possible payee indicators from the analyzed image 202 correspond to confirmed payee indicators that are stored in the database. Confirmed payee indicators may be stored in the database by payees (e.g., a movie theater payee may provide payee indicator(s) that are associated with movies showing at movie theaters run by that movie theater payee) and/or other entities that may wish to enable the method of the present disclosure (e.g., an entertainment company may provide payee indicator(s) for a particular movie and indicate which movie they should be associated with rather than the movie theater payee.) In the illustrated embodiment, the image 202 is analyzed to determine that the payee indicator 204a (e.g., an image on a movie poster associated with a movie) is a possible payee indicator, and then a database is accessed and it is determined that the payee indicator 204a corresponds to a confirmed payee indicator in the database, and/or determine that the payee indicator 204b (e.g., a movie name, a movie tagline, and/or other phrase or character string associated with a movie) is a possible payee indicator, and then a database is accessed and it is determined that the payee indicator 204b corresponds to a confirmed payee indicator in the database. In an embodiment, a confirmed payee indicator includes information for the movie that the confirmed payee indicator is associated with.

Referring now to FIGS. 1a and 2b, the illustrated embodiment of the method 100 has a modified block 110 where payee information is retrieved using a payee indicator. As discussed above, the payee indicators 204a and/or 204b, which are now confirmed payee indicators, include information for the movie with which they are associated. The payer device 102b may determine its current location (e.g., by asking for a location to be input by the payer 102b, using a location sensor included in the payer device 102b, and/or a variety of other location determining methods known in the art), and using information from the payer (e.g., retrieved from the payer device 102b) and the information associated with the payee indicators 204a and/or 204b, access one or more databases to retrieve movie theater information that is related to the movie associated with the payee indicators 204a and/or 204b. For example, upon determination of the current location of the payer device 102b, a database may be accessed that includes one or more movies theaters that are “close” to the current location of the payer device 102b along with the movies and associated movie show times at those theaters, and using the information associated with the payee indicators 204a and/or 204b, the movie associated with the payee indicators 204a and/or 204b along with the show times at each theater for that movie may be retrieved. In an embodiment, the search area for movie theaters that are “close” to the current location of the payer device 102b may depend on a distance determined between the payer device 102b and the movie advertisement 200. For example, the payer device 102b may include sensors and/or software to determine the distance between the payer device 102b and the movie advertisement 200, and as that distance increases, the search area for movie theaters that are “close” to the current payer device 102b increases as well. This allows the payer 102a to quickly and easily indicate a desired search area for movie theaters near the payer device 102b that is integrated into the taking of the image to make the payment.

Referring now to FIGS. 1a and 2c, the illustrated embodiment of the method 100 has a modified block 112 where the payee information is displayed. Information determined in blocks 108 and 110 of the method 100 may be displayed on the display 106 of the payer device 102b. For example, in the illustrated embodiment in FIG. 2c, a movie name 206 and a movie image 208 associated with a movie are displayed adjacent a statement that informs the payer that they have indicated they would like a payment to a payee to see the movie. In an embodiment, the movie name 206 may be the payee indicator 204b described above (e.g., when the payee indicator 204b is a movie name), and the movie image 208 may be retrieved from a database due to its association with the payee indicator 204b. In an embodiment, the movie image 208 may be the payee indicator 204a described above (e.g., when the payee indicator 204a is a movie image associated with the movie), and the movie name 206 may be retrieved from a database due to its association with the payee indicator 204a. In an embodiment, the movie name 206 and movie image 208 may be the payee indicator 204b and payee indicator 204a, respectively (e.g., when the payee indicator 204a is a movie image associated with the movie and the payee indicator 204b is a movie name.) In an embodiment, the movie name 206 and movie image 208 may be retrieved from a database due to their association with the payee indicator(s) 204a and/or 204b (e.g., when the payee indicator 204a is a movie image associated with the movie but different from the payee indicator 204a and/or when the payee indicator 204b is a movie tagline.)

In the illustrated embodiment, a first theater section 210 is displayed. For example, in block 110 of the method 100, it is determined that a first theater (MOVIE THEATER A) is located 0.1 miles from the current location of the payer device 102b, and a theater name 210a, a theater distance 210b, a plurality of movie show times 210ca, 210cb, 210cc, and 210cd, a payee option such as a ticket input 210d, and a Pay button 210e are displayed in the first theater section 210.

In the illustrated embodiment, a second theater section 212 is displayed. For example, in block 110 of the method 100, it is determined that a second theater (MOVIE THEATER B) is located 0.7 miles from the current location of the payer device 102b, and a theater name 212a, a theater distance 212b, a plurality of movie show times 212ca, 212cb, 212cc, and 212cd, a payee option such as a ticket input 212d, and a Pay button 212e are displayed in the second theater section 212.

In the illustrated embodiment, a third theater section 214 is displayed. For example, in block 110 of the method 100, it is determined that a third theater (MOVIE THEATER C) is located 2.0 miles from the current location of the payer device 102b, and a theater name 214a, a theater distance 214b, a plurality of movie show times 214ca, 214cb, 214cc, and 214cd, a payee option such as a ticket input 214d, and a Pay button 214e are displayed in the third theater section 214.

Referring now to FIGS. 1a and 2c, the illustrated embodiment of the method 100 has a modified block 126 where a request is sent to make a payment to a payee using the payee information. The payer 102a may use the first theater section 210, the second theater section 212, or the third theater section 214 to send a request (e.g., over a network) to a payment service provider to make a payment to a payee. For example, the payer 102a may use the first theater section 210 to select one of the plurality of movie show times 210ca, 210cb, 210cc, or 210cd (the movie show time 210ca is shown automatically selected in the illustrated embodiment, for example, in response to that movie show time being determined to be closely to a current time), input a payment variable such as a number of tickets desired for the movie associated with the movie name 206 and/or movie image 208 (e.g., 2), and select the Pay button 210e, and a request will be sent to the payment service provider to send a payment for an amount associated with 2 tickets to the movie to a payee associated with MOVIE THEATER A. In an embodiment, selection of the Pay button 210e may be interpreted as a confirmation or authorization by the payer to the payment service provider to make the payment. In an unillustrated embodiment, a separate confirmation or authorization may be requested for the amount of the payment. One of skill in the art will recognize that the second theater section 212 and the third theater section 214 may be used substantially as described above if the payer 102a desires to purchase tickets to see a movie at those movie theaters.

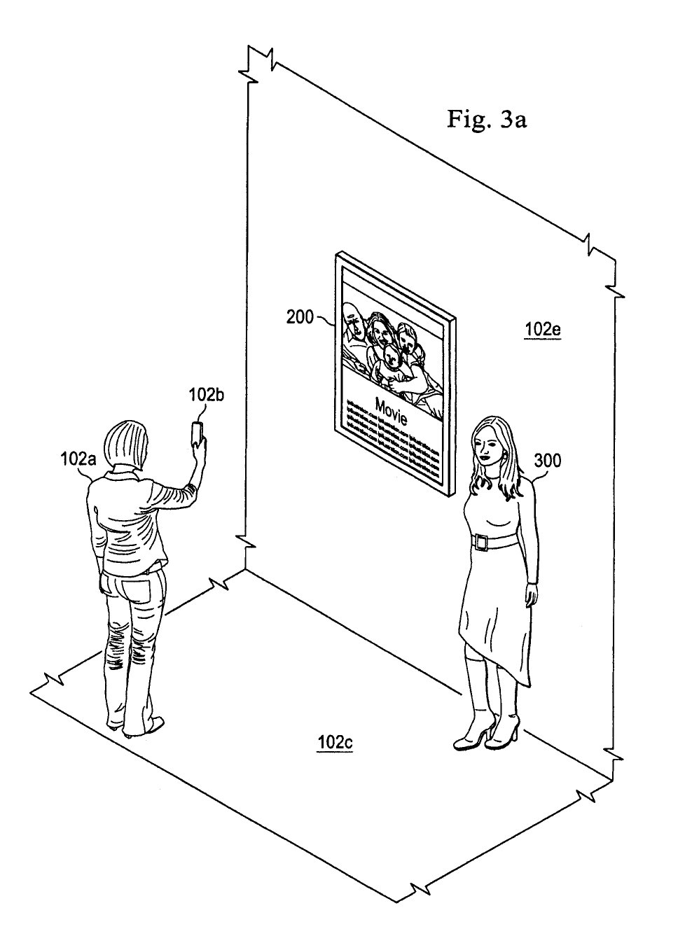

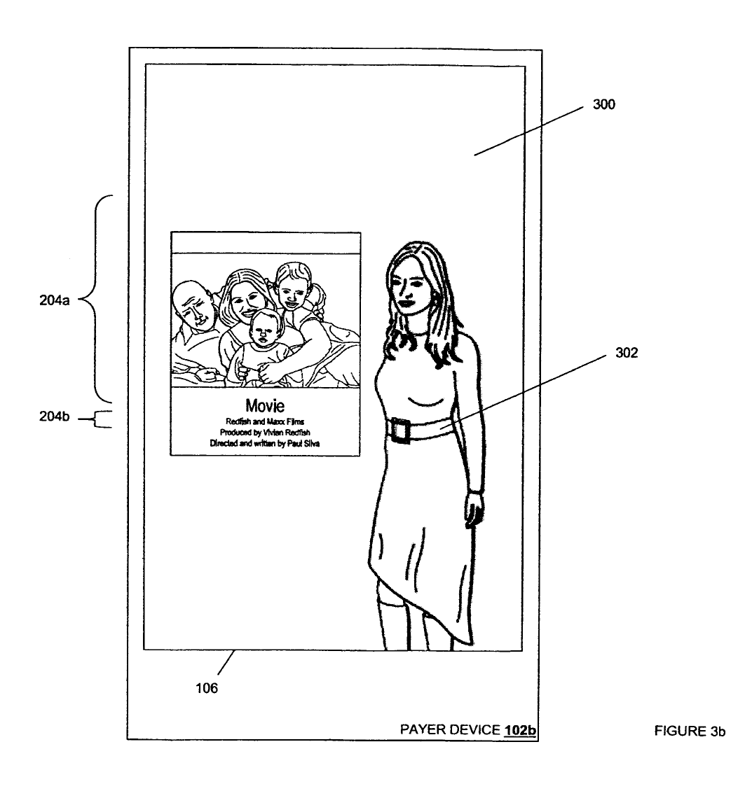

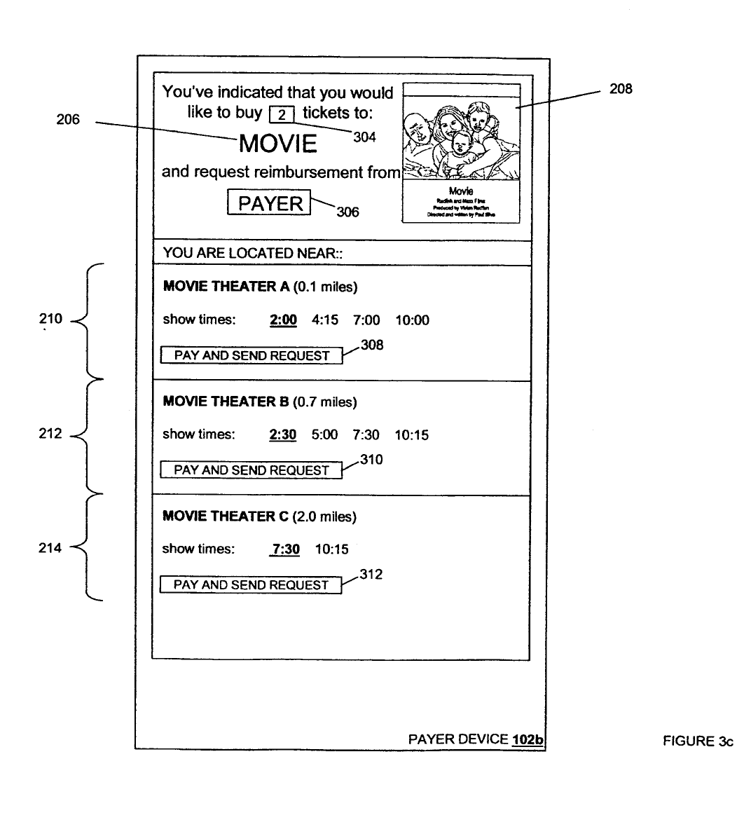

Referring now to FIGS. 1a, 3a, 3b, and 3c, another embodiment of the method 100 is illustrated. The illustrated embodiment has a modified block 102 where an image is received that is substantially similar to the block 102 described above with reference to FIG. 2a except that the image 300 received includes a secondary payer 302 along with the payee indicators 204a and 204b, as illustrated in FIGS. 3a and 3b.

Referring now to FIGS. 1a and 3b, the illustrated embodiment of the method 100 has a modified block 108 where the image is analyzed and it is determined that a payee indicator and a secondary payer are included in the image. The image 202 received in block 102 of the method 100 may also be analyzed using facial recognition technologies and techniques to determine that the image includes a secondary payer 302. In the embodiment illustrated in FIG. 3b, the image 202 may be analyzed and it may be determined that the secondary payer 302 is a possible secondary payer, and then a database may be accessed (e.g., on the payer device 102b and/or over a network) to determine if the possible secondary payer 302 from the analyzed image 300 corresponds to a confirmed secondary payer that is stored in the database. Confirmed secondary payers may be stored in the database by the secondary payers and/or the payment service provider In the illustrated embodiment, the image 202 is analyzed to determine that the secondary payer 302 is a possible secondary payer, and then a database is accessed and determined that the secondary payer 302 corresponds to a confirmed secondary payer in the database. In an embodiment, a confirmed secondary payer 302 includes information associated with the secondary payer 302 such as a secondary payer name, secondary payer contact information, a secondary payer account, and/or a variety of other secondary payer information known in the art.

Referring now to FIG. 1a, the illustrated embodiment of the method 100 has a modified block 110 where secondary payer information is retrieved using the secondary payer 302. As discussed above, the secondary payer 302, which is now a confirmed secondary payer, includes information associated with the secondary payer 302. In addition to retrieving a current location and information from the payer, payee information about the secondary payer 302 may be retrieved.

Referring now to FIGS. 1a and 3c, the illustrated embodiment of the method 100 has a modified block 112 where the payee information and secondary payer information is displayed. Information determined in blocks 108 and 110 of the method 100 may be displayed on the display 106 of the payer device 102b. The determination of the secondary payer 302 allows the method to assume that the payer 102a would like tickets for themselves and the secondary payer 302, and a payee option such as an editable ticket box 304 may be pre-filled with a payment variable (e.g., 2 tickets.) Also, an editable reimbursement request box 306 is displayed adjacent a statement that informs the payer that they have indicated they would like to request a reimbursement from the secondary payer 302, and the editable reimbursement request box 306 is pre-filled with information (e.g., a secondary payer name) associated with the secondary payer 302.

In the illustrated embodiment, the first theater section 210, second theater section 212, and third theater section 214 are substantially similar to those described above with reference to FIG. 2c, with the removal of the ticket inputs 210d, 212d, and 214d (due to the number of tickets being specified in the editable ticket box 304), and the replacement of the Pay buttons 210e, 212e, and 214e with Pay And Send Request buttons 308, 310, and 312, respectively. In an embodiment, the Pay And Send Request buttons 308, 310, and 312 operate substantially the same as the Pay buttons 210e, 212e, and 214e discussed above with the exception that they also result in a request being sent to the payment service provider to request a reimbursement for the payer 102a from the secondary payer 302 for a portion of the payment made to the payee in the method 100. For example, in the illustrated embodiment, the reimbursement request may be sent to the secondary payer 302 for one of the two tickets purchased to the movie. In an embodiment, selection of the any of the Pay And Send Request buttons 308, 310, and 312 may be interpreted as a confirmation or authorization by the payer to the payment service provider to make the payment and send the reimbursement request to the secondary payer 302. One of skill in the art will recognize that a variety of functionality may be provided to the embodiment illustrated in FIGS. 3a, 3b, and 3c such as, for example, more than one secondary payers may be recognized and sent a reimbursement request, reimbursement requests may be edited to request reimbursements for specific portions of the purchase, and/or a variety of other functionality without departing from the scope of the present disclosure.

Thus, a system and method for making a payment using an image with the assistance of a payment service provider has been described that allow a payer to take an image using a camera on a mobile device that may then be used to determine a payment due to a payee, and then to quickly and easily make that payment. In one embodiment, the payer may provide payment variables that modify the amount of the payment due to the payee and/or provide a confirmation of the payment. In another embodiment, the payment may be automatically paid in response to determining the payee indicator is included in the image.

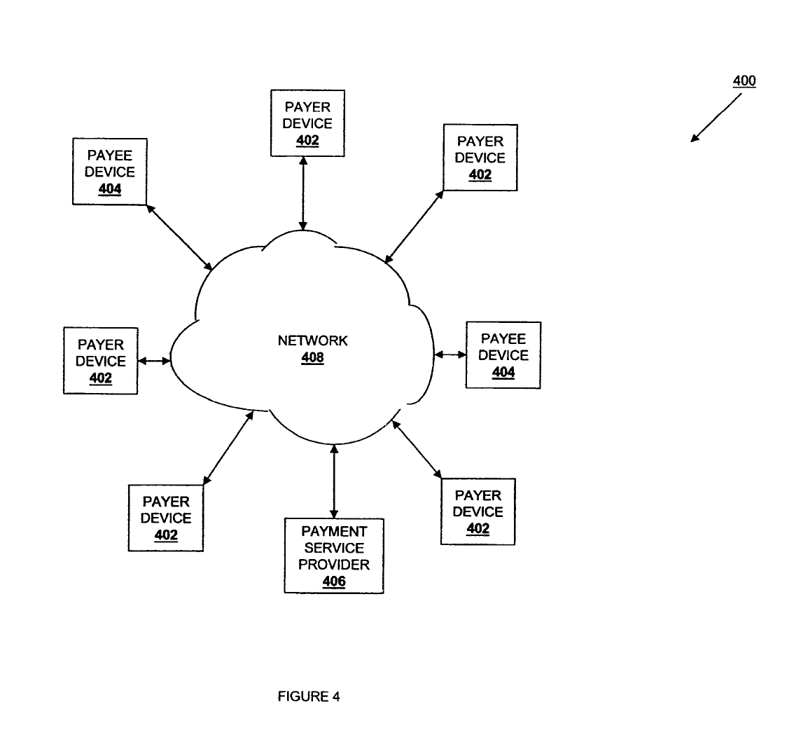

Referring now to FIG. 4, an embodiment of a networked system 400 used in the payment system using images is illustrated. The networked system 400 includes a plurality of payer devices 402, a plurality of payee devices 404, and a payment service provider 406 in communication over a network 408. Any of the payer devices 402 may be the payer device 102b. The payee devices 404 may be payee devices associated with any of the payees discussed above. The payment service provider 408 may be a payment service provider such as, for example, PayPal Inc. of San Jose, Calif.

The payer devices 402, payee devices 404, and a payment service provider 406 (discussed in further detail below) may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 400, and/or accessible over the network 408.

The network 408 may be implemented as a single network or a combination of multiple networks. For example, in various embodiments, the network 408 may include the Internet and/or one or more intranets, landline networks, wireless networks, and/or other appropriate types of networks.

The payer device 402 may be implemented using any appropriate combination of hardware and/or software configured for wired and/or wireless communication over network 408. For example, in one embodiment, the payer device 402 may be implemented as a personal computer of a payer in communication with the Internet. In other embodiments, the payer device 402 may be a smart phone, personal digital assistant (PDA), laptop computer, and/or other types of computing devices.

The payer device 402 may include one or more browser applications which may be used, for example, to provide a convenient interface to permit the payer to browse information available over the network 408. For example, in one embodiment, the browser application may be implemented as a web browser configured to view information available over the Internet.

The payer device 402 may also include one or more toolbar applications which may be used, for example, to provide payer-side processing for performing desired tasks in response to operations selected by the payer. In one embodiment, the toolbar application may display a user interface in connection with the browser application.

The payer device 402 may further include other applications as may be desired in particular embodiments to provide desired features to the payer device 402. In particular, the other applications may include a payment application for payments through the payment service provider 406. The other applications may also include security applications for implementing user-side security features, programmatic user applications for interfacing with appropriate application programming interfaces (APIs) over the network 408, or other types of applications. Email and/or text applications may also be included, which allow the payer to send and receive emails and/or text messages through the network 408. The payer device 402 includes one or more user and/or device identifiers which may be implemented, for example, as operating system registry entries, cookies associated with the browser application, identifiers associated with hardware of the payer device 402, or other appropriate identifiers, such as a phone number. In one embodiment, the user identifier may be used by the payment service provider 406 to associate the payer with a particular account maintained by the payment service provider 406 as further described herein.

The payee device 404 may be maintained, for example, by an on-line merchant, digital goods seller, individual seller, and/or application developer offering various products and/or services in exchange for payment to be received over the network 408. In this regard, the payee device 404 may include a database identifying available products and/or services (e.g., collectively referred to as items) which may be made available for viewing and purchase by the payer.

The payee device 404 also includes a checkout application which may be configured to facilitate the purchase by the payee of items. The checkout application may be configured to accept payment information from the payee and/or from the payment service provider 406 over the network 408.

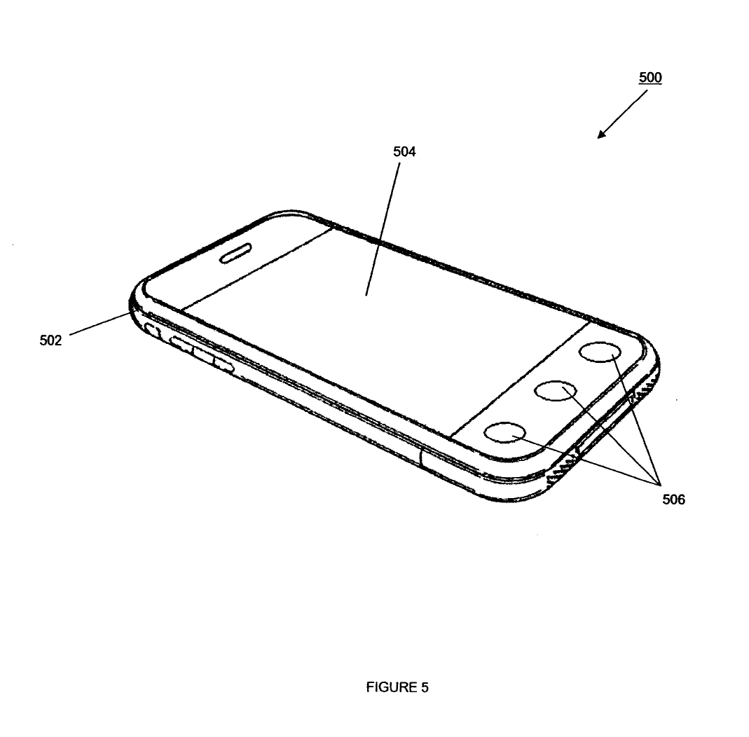

Referring now to FIG. 5, an embodiment of a payer device 500 is illustrated. The payer device 500 may be the payer device 102b. The payer device 500 includes a chassis 502 having a display 504 and an input device including the display 504 and a plurality of input buttons 506. One of skill in the art will recognize that the payer device 500 is a portable or mobile phone including a touch screen input device and a plurality of input buttons that allow the functionality discussed above with reference to the method 100. However, a variety of other portable or mobile payer devices may be used in the method 100 without departing from the scope of the present disclosure.

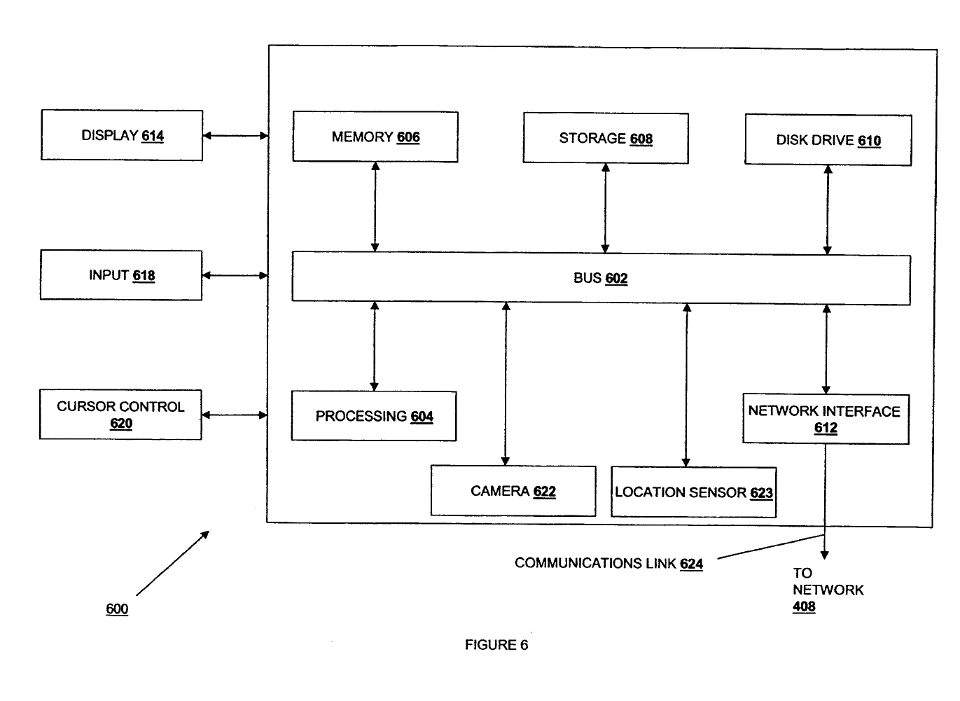

Referring now to FIGS. 4 and 6, an embodiment of a computer system 600 suitable for implementing, for example, the payer device 102b, is illustrated. In various implementations, the payer device(s) may comprise a computing device (e.g., a computer, laptop, smart phone, PDA, etc.) capable of communicating with the network 408. Furthermore, payee device(s) and/or the payment service provider 406 may implement the computer system 600 as well. It should be appreciated that other devices utilized by payers, payees, and payment service providers in the payment system using images may be implemented as the computer system 600 in a manner as follows.

In accordance with various embodiments of the present disclosure, computer system 600, such as a computer and/or a network server, includes a bus 602 or other communication mechanism for communicating information, which interconnects subsystems and components, such as a processing component 604 (e.g., processor, micro-controller, digital signal processor (DSP), etc.), a system memory component 606 (e.g., RAM), a static storage component 608 (e.g., ROM), a disk drive component 610 (e.g., magnetic or optical), a network interface component 612 (e.g., modem or Ethernet card), a display component 614 (e.g., CRT or LCD), an input component 618 (e.g., keyboard, keypad, or virtual keyboard), a cursor control component 620 (e.g., mouse, pointer, or trackball), a camera 622, and/or a location sensor 623 (e.g., a Global Positioning System (GPS) device, a cell tower triangulation device, and/or a variety of other location sensors known in the art.) In one implementation, the disk drive component 610 may comprise a database having one or more disk drive components.

In accordance with embodiments of the present disclosure, the computer system 600 performs specific operations by the processor 604 executing one or more sequences of instructions contained in system the memory component 606, such as described herein with respect to the payer device 102b, 402, 500, the payee device(s) 404, and/or the payment service provider 406. Such instructions may be read into the system memory component 606 from another computer readable medium, such as the static storage component 608 or the disk drive component 610. In other embodiments, hard-wired circuitry may be used in place of or in combination with software instructions to implement the present disclosure.

Logic may be encoded in a computer readable medium, which may refer to any medium that participates in providing instructions to the processor 604 for execution. Such a medium may take many forms, including but not limited to, non-volatile media, volatile media, and transmission media. In various implementations, non-volatile media includes optical or magnetic disks, such as the disk drive component 610, volatile media includes dynamic memory, such as the system memory component 606, and transmission media includes coaxial cables, copper wire, and fiber optics, including wires that comprise the bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 600. In various other embodiments of the present disclosure, a plurality of the computer systems 600 coupled by a communication link 624 to the network 408 (e.g., such as a LAN, WLAN, PTSN, and/or various other wired or wireless networks, including telecommunications, mobile, and cellular phone networks) may perform instruction sequences to practice the present disclosure in coordination with one another.

The computer system 600 may transmit and receive messages, data, information and instructions, including one or more programs (i.e., application code) through the communication link 624 and the network interface component 612. The network interface component 612 may include an antenna, either separate or integrated, to enable transmission and reception via the communication link 624. Received program code may be executed by processor 604 as received and/or stored in disk drive component 610 or some other non-volatile storage component for execution.

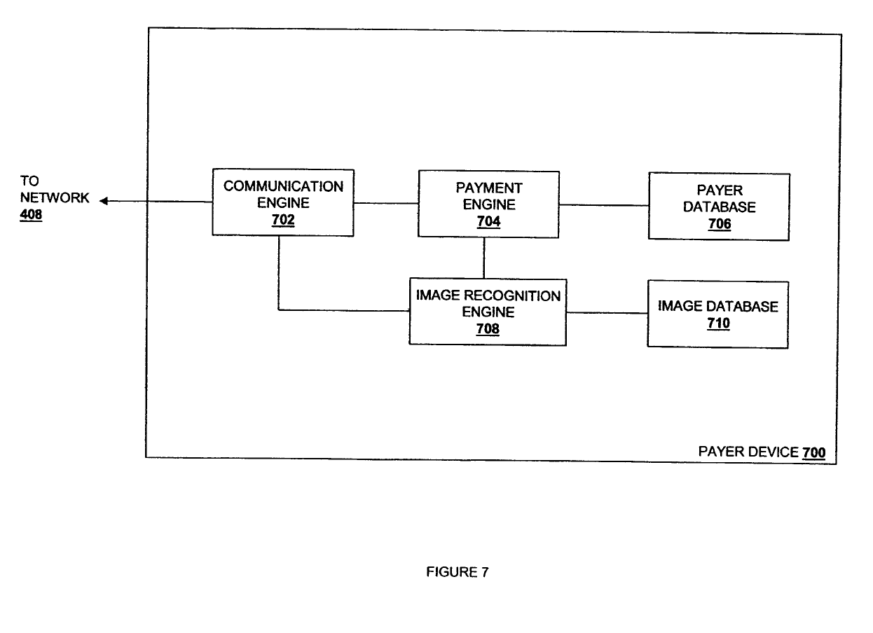

Referring now to FIGS. 4 and 7, an embodiment of a payer device 700 is illustrated. The payer device includes a communication engine 702 that is coupled to the network 408, a payment engine 704 that is coupled to a payer database 706, and an image recognition engine 708 that is coupled to the payment engine 708 and an image database 710. The communication engine 702 may be software or instructions stored on a computer-readable medium that allows the payer device 700 to send and receive information over the network 408. The image recognition engine 708 may be software or instructions stored on a computer-readable medium that is operable to receive an image from the communication engine 702 and perform image, character, and/or facial recognition techniques on the image to determine possible payee indicators and/or secondary payers, and then access the image database 710 to determine whether those payee indicators and/or secondary payers are associated with payees and/or secondary payers in the image database 710, as discussed above. The payment engine 704 may be software or instructions stored on a computer-readable medium that is operable to receive information from the communication engine 702 and payee information from the image recognition engine 708, retrieve payer information from the payer database 706, and present the payer information to the payer though the payer device, as discussed above. While the payer database 706 and/or the image database 710 have been illustrated as located in the payer device 700, one of skill in the art will recognize that they may be connected to the payment engine 704 and the image recognition engine 708, respectively, through the network 408 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and seller; however, a user or consumer can pay virtually, or otherwise interact with any type of recipient, including charities and individuals. The payment does not have to involve a purchase, but can be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

1. A method for making a payment using an image, comprising:
receiving an image from a camera;
analyzing the image using a processor and determining that a payee indicator is included in the image;
matching the payee indicator determined to be included in the image with a confirmed payee indicator in a database;
retrieving payee information from a database using the confirmed payee indicator;
calculating at least one payment owed to a payee associated with the confirmed payee indicator subsequent to the confirming the payee indicator; and
sending a request to make a payment to the payee over a network for the at least one payment owed.

2. The method of claim 1, wherein the method further comprises:
displaying the payee information on a display; and
receiving a confirmation, related to the request to make a payment to the payee, from an input device, wherein the sending the request to make the payment is performed in response to receiving the confirmation.

3. The method of claim 2, wherein the retrieving and displaying the payee information comprises retrieving and displaying a current amount due to the payee and a due date for the payment.

4. The method of claim 2, wherein the retrieving and displaying the payee information comprises retrieving and displaying a plurality of payments made to the payee.

5. The method of claim 2, wherein the retrieving and displaying the payee information comprises retrieving and displaying at least one payee option and the method further comprises:
receiving at least one payment variable provided through the at least one payee option from the input device; and
calculating an amount of the at least one payment owed to the payee associated with the confirmed payee indicator using the at least one payment variable.

6. The method of claim 2, further comprising:
determining a current location using a location sensor, wherein the payee information is retrieved from the database using the payee indicator and the current location.

7. The method of claim 1, wherein the analyzing the image using a processor further comprises:
analyzing the image using the processor and determining that a secondary payer is included in the image; and
calculating the at least one payment owed to the payee associated with the confirmed payee indicator using the secondary payer.

8. The method of claim 7, further comprising:
sending a reimbursement request to the secondary payer over the network.

9. A machine-readable medium comprising a plurality of machine-readable instructions which, when executed by one or more processors, are adapted to cause the one or more processors to perform a method comprising:
receiving an image from a camera;
analyzing the image to determine that a payee indicator is included in the image;
confirming the payee indicator;
retrieving payee information from a database using the confirmed payee indicator, wherein the payee information includes at least one payment owed to a payee associated with the confirmed payee indicator, and wherein the at least one payment owed to the payee is calculated subsequent to confirming the payee indicator; and
sending a request to make a payment to the payee over a network for the at least one payment owed.

10. The machine-readable medium of claim 9, wherein the plurality of machine-readable instructions, when executed by the one or more processors, are adapted to cause the one or more processors to perform the method further comprising:
displaying the payee information on a display; and
receiving a confirmation, related to the request to make the payment to the payee, from an input device, wherein the sending the request to make the payment is performed in response to receiving the confirmation.

11. The machine-readable medium of claim 10, wherein the retrieving and displaying the payee information comprises retrieving and displaying a current amount due to the payee and a due date for the payment.

12. The machine-readable medium of claim 10, wherein the retrieving and displaying the payee information comprises retrieving and displaying a plurality of payments made to the payee.

13. The machine-readable medium of claim 10, wherein the retrieving and displaying the payee information comprises retrieving and displaying at least one payee option, and wherein the plurality of machine-readable instructions, when executed by the one or more processors, are adapted to cause the one or more processors to perform the method further comprising:
receiving at least one payment variable provided through the at least one payee option from the input device; and
calculating an amount of the at least one payment owed to the payee associated with the confirmed payee indicator using the at least one payment variable.

14. The machine-readable medium of claim 10, wherein the plurality of machine-readable instructions, when executed by the one or more processors, are adapted to cause the one or more processors to perform the method further comprising:
determining a current location using a location sensor, wherein the payee information is retrieved from the database using the payee indicator and the current location.

15. The machine-readable medium of claim 9, wherein the plurality of machine-readable instructions, that when executed by the one or more processors, are adapted to cause the one or more processors to analyze the image further comprise a plurality of machine-readable instructions, that when executed by the one or more processors, are adapted to cause the one or more processors to perform the method further comprising:
analyzing the image using the processor and determining that a secondary payer is included in the image; and
calculating the at least one payment owed to the payee associated with the confirmed payee indicator using the secondary payer.

16. The machine-readable medium of claim 15, wherein the plurality of machine-readable instructions, when executed by the one or more processors, are adapted to cause the one or more processors to perform the method further comprising:
sending a reimbursement request to the secondary payer over a network.

17. A payment system using images, comprising:
means for receiving an image;
means for analyzing the image and determining that a payee indicator is included in the image;
means for confirming the payee indicator;
means for retrieving payee information using the payee indicator;
means for calculating at least one payment owed to a payee associated with the confirmed payee indicator subsequent to confirming the payee indicator; and
means for sending a request to make a payment to the payee for the at least one payment owed.

18. The system of claim 17, further comprising:
means for displaying the payee information; and
means for receiving a confirmation related to the request to make the payment to the payee, wherein the sending the request to make the payment is performed in response to receiving the confirmation.

19. The system of claim 17, further comprising:
means for receiving at least one payment variable; and
means for calculating an amount of the at least one payment owed to the payee associated with the confirmed payee indicator using the at least one payment variable.

20. The system of claim 17, further comprising:
means for analyzing the image using the processor and determining that a secondary payer is included in the image; and
means for calculating the at least one payment owed to the payee associate with the confirmed payee indicator using the secondary payer.
